(19) United States
(12) Patent Application Publication
(10) Pub. No.: US 2011/0318231 A1
(43) Pub. Date: Dec. 29, 2011

(54) Carbon Dioxide Capture System for Diminution of Global CO2 Levels

(76) Inventors: Wilson Hago, Camarillo, CA (US); Andre Coustant Morin, Santa Barbara, CA (US)

(21) Appl. No.: 13/158,463

(22) Filed: Jun. 13, 2011

Related U.S. Application Data
(60) Provisional application No. 61/359,298, filed on Jun. 28, 2010.

(51) Int. Cl. B01D 53/00

(52) U.S. Cl. 422/105

(57) ABSTRACT

A system is demonstrated which captures carbon dioxide from the atmosphere by introducing air into the vehicle at high speeds and reacting such air with hydroxide-containing material. System comprises means for introducing air into vehicle, means for reacting the air in reaction vessels and means for stopping the carbon dioxide scrubbing once a predetermined carbonate concentration is reached in the solution.

### RELATED APPLICATION

This application claims the benefit of Provisional Application 61359298, filed on Jun. 28, 2010.

### TECHNICAL FIELD

The present invention relates generally to a system for carbon dioxide capture, in particular a carbon dioxide capture system adapted to mobile applications such as transport vehicles, including land, air and marine vehicles.

### DESCRIPTION OF THE RELATED ART

Severe global consequences are predicted for the continual production of carbon dioxide (CO₂) from industrial and automobile sources. Ocean levels are predicted to rise during the next several decades, bringing unwelcome global dislocations to billions of people. Rising global temperatures are expected to lead to extreme weather events, ozone depletion, animal and plant extinctions, and more pronounced spread of diseases. A contribution to this warming is exhaust emissions from various industrial sources, and, in particular transportation sources.

Anthropogenic carbon emissions have been rising dramatically since the start of the Industrial Revolution circa 1750. Present worldwide carbon dioxide emissions are 30 G tons/year and are expected to rise as China and India become more industrialized. Carbon dioxide levels have remained below 900 ppm for the past 60 million years and below 350 ppm for the past 25 million years. Present CO₂ levels are 390 ppm and are rising 1 to 2 ppm every year. Some scenarios call for planetary carbon dioxide levels reaching 1000 ppm by the year 2100. Recent data indicates that we are on a trajectory that follows this worst case scenario. These levels would be outside the range of mammalian evolution. Indeed, at 600 ppm some individuals report the air to be stuffy. It is prudent for us to take steps to maintain CO₂ levels at levels consistent with mammalian history. Accordingly, the present invention aims to contribute to the reduction of global atmospheric carbon dioxide levels via the use of a carbon dioxide capture system in mobile applications. A method is desired that can process air at relatively high speeds.

Prior art exists for the capture of CO₂ from the atmosphere. In US Application 20080087165 Wright and Lackner discuss a method and apparatus for extracting carbon dioxide from air involving an anion exchange material formed in a matrix exposed to a flow of the air, and for delivering that extracted CO₂ to controlled environments such as a greenhouse. Lackner has also proposed building large towers with areas of 50 m² to 60 m² and bringing air to pass through the towers. See Lackner, K. S. Capture of Carbon Dioxide from Air. European Journal of Physics 176, 93 (2009). The towers contain a large surface area sorbent that binds CO₂ from ambient air. Air exits with a lower concentration of CO₂. These ideas have in common passing large amounts of air through a sorbent and then regenerating the sorbent.

Rau et al (U.S. Pat. No. 6,890,497) discuss a method and apparatus to sequester carbon dioxide from a stream wherein the carbon dioxide is at first hydrated to yield carbonic acid. The resulting carbonic acid is then reacted with carbonate to yield bicarbonate in solution ordehydrated metal salts. Nalette et al (U.S. Pat. No. 6,755,892) discuss the use of an amine/nitrile sorbent to sequester carbon dioxide from an incoming gas stream for automobile exhaust gases.

Scappatura, et al. (U.S. Pat. No. 5,857,324) teach an apparatus for removing gasses and particulate matter from internal combustion engine exhaust, said apparatus comprising a heat exchanger, a fluid separator, a holding tank, and two chemical reactors, one of which reacts aqueous hydroxide with carbon dioxide. Suzuki et al (U.S. Pat. No. 5,667,561) discusses reducing the carbon dioxide levels in waste gas of combustion via the use of europium oxide. Simuni (U.S. Pat. No. 5,175,998) discusses decreasing carbon dioxide in automobile exhaust by dissolving the carbon dioxide in water to form carbonic acid. In our present invention we do not form carbonic acid.

Parker et al (U.S. Pat. No. 5,443, 804) discusses reacting carbon dioxide in a water vapor-bearing waste gas stream from one burning fossil fuel with a bed of basic metal oxide such as ZnO or ZrO2 at a temperature between 330° C. to 380° C. Mitsuda (U.S. Pat. No. 6,866,702) teaches carbon dioxide absorbing material located along the automobile exhaust pipe that includes CaO enclosed inside the housing; wherein a gas is passed through the housing to absorb carbon dioxide in the gas, wherein the carbon dioxide absorbing material includes CaO is selected from the group consisting of various cements. Wright et al (US 20070217982) discuss a method of capturing ambient carbon dioxide by reaction with NaOH from a chlor-alkali process using an anion exchange resin such as cellulose or polystyrene in various type of geometrical matrices. In another patent US20060051274 Wright et al discuss removing carbon dioxide from the air by exposing a hydroxide solvent to a laminar flow of air.

The present invention exploits the fact that transport vehicles, by virtue of their operation, encounter a large amount of air and that this amount of air can be scrubbed of carbon dioxide while the vehicle is in operation. The novelty of the present invention relies on utilizing this significant fast air flow for CO₂ capture. The present invention aims to capture carbon dioxide for vehicles traveling at a range of speeds, and in particular, with speeds from 0 to 60 mph (30 m/sec). Assuming a speed of 20 m/sec, an effective capture area of 1 m² and a typical sorbent capture rate of 150 micromoles/m²/sec , one automobile could capture 11 kg CO2 per day. If every automobile in the United States were to have one of these capture devices, this would represent a removal of 800 million tons of CO₂ from the atmosphere. This is 15% of present US automobile yearly CO₂ emissions and 5% of world yearly CO₂ emisssions. This would represent a significant diminution in global CO₂ emissions.

The best known CO₂ capture approach involves the use of structured packing towers. In these structures, a high surface area ceramic serves as the means to increase contact between the liquid NaOH solution and the incoming CO₂. Typical capture rates are 150 micromoles/m² /sec for 2M NaOH at an air speed of 2 m/sec. (Baciocchi et al. Chemical Engineering and Processing 45, 1047 (2006)). Larger surface areas approaches include the use of spray towers and the use of falling films . These two methods significantly increase the capture rate, but these methods have been tested with air speeds considerably less than 2 m/sec. As mentioned previously, a method is desired that can process air with speeds compatible with typical vehicular speeds.

The present invention can be installed in any vehicle that burns fuels that produce carbon emissions. It may also be applied to an engine that burns non-carbon based fuels, such as hydrogen. The present invention relies on utilizing incoming air from a vehicle during its normal operation and reacting that air with hydroxide-containing material for the purpose of extracting carbon dioxide from the atmosphere. This is typically an intensive energy task due to the small concentration of carbon dioxide in air (390 ppm by volume as of the present year). Prior art do not show effective methods of removing carbon dioxide in fast moving air through vehicles. The present invention comprises a system that includes the following: i) a means for collecting incoming air in a vehicle ii) a means for reacting the incoming air with hydroxide containing material and iii) a means for determining the carbonate concentration in a hydroxide-containing material and iv) a means for recirculating carbonate laden hydroxide until a certain carbonate concentration is reached.

Our invention is a system that incorporates the reaction of alkali with CO₂, but does not rely on an anion exchange resin for its operation. It also does not rely on laminar flow.

### DESCRIPTION OF THE FIGURES

FIG. 1 is an illustration of an embodiment of the present invention in which liquid and gas flow in a countercurrent fashion.

FIG. 2 is an illustration of another embodiment of the present invention in which liquid and gas flow in a concurrent fashion.

### BRIEF SUMMARY OF THE INVENTION

The basic system comprises the following: i) a means for collecting incoming air in a vehicle, ii) a means for reacting the incoming air with hydroxide containing material, iii) a means for determining the concentration of carbonate in the hydroxide containing solution, and iv) a means for recirculating carbonate-laden hydroxide until a certain carbonate concentration is reached. The full nature of the invention will become apparent through the following description of embodiments of the invention.

### DETAILED DESCRIPTION OF EMBODIMENTS OF THE INVENTION

In the present invention, incoming air is directed through the front or sides of the vehicle in order to expose the air to a high surface area environment filled with a liquid hydroxide-containing solution. The high surface area environment allows for maximum liquid-gas contact. A countercurrent or co-current flow design for the liquid-gas may be used. A maximum amount of area is desired for the air entry. Some embodiments use a total surface area ranging from 0.1 m² to 10 m², depending on the available surface area in the vehicle. Some embodiments remove the radiator to the side of the vehicle in order to allow for proper air flow, while other embodiments modify the radiator to allow the coexistence of liquid cooling and the air entry. Other embodiments remove the radiator completely and opt for the use of an air-cooled engine instead. An air-cooled engine powered using hydrogen as fuel is described in co-owned U.S. Pat. No. 7,707,976. This engine is a 5-cylinder engine with two compressible chambers. A proper consideration is maximum air flow without significantly affecting the vehicle fuel efficiency. An equally important consideration is that the flow of air does not dry out the hydroxide solution. An optional variable flap at the front of the vehicle controls the inflow of air and may serve to completely stop the flow of air to be processed through the scrubbers.

In the present invention vehicular carbon dioxide capture is accomplished via the well-known reaction of ambient CO₂ with aqueous base circulated in CO₂ scrubber columns It is well known that alkali base is an efficient scrubber of CO₂. In our system the aqueous base is carried on board. The relevant reactions are:

2NaOH+CO₂→Na₂CO₃+H₂O ΔH°_{298K}=−128 kJ/mol

NaOH+CO₂→NaHCO₃ ΔH°_{298K}=−132 kJ/mol

The reactions could work with any cations from group I (for example Li⁺, Na⁺, K⁺), group II, group III, transition metals, or ammonia containing cations, such as NH₄⁺, but Na⁺ is the most economical. The resulting carbonate ions are fairly soluble in the alkali solution. Once captured, the carbonate-laden solution can be exchanged with fresh hydroxide, preferably at the same time and place during refueling. The carbonate-laden solution would be treated off-site where it would be dried and the carbonate heated to regenerate the CO₂ per the following equation:

Na₂CO₃→CO₂+Na₂O (860° C.)

The resulting sodium oxide from the decomposition could be reacted with water to regenerate the sodium hydroxide per the following reaction:

Na₂O+H₂O→2NaOH

A variation of this process is the Kraft Process, in which calcium hydroxide is reacted with the sodium carbonate to render the more insoluble calcium carbonate:

Ca(OH)₂+Na₂CO₃→CaCO₃+2NaOH

The initial decomposition temperature of the calcium carbonate is similar to the sodium carbonate.

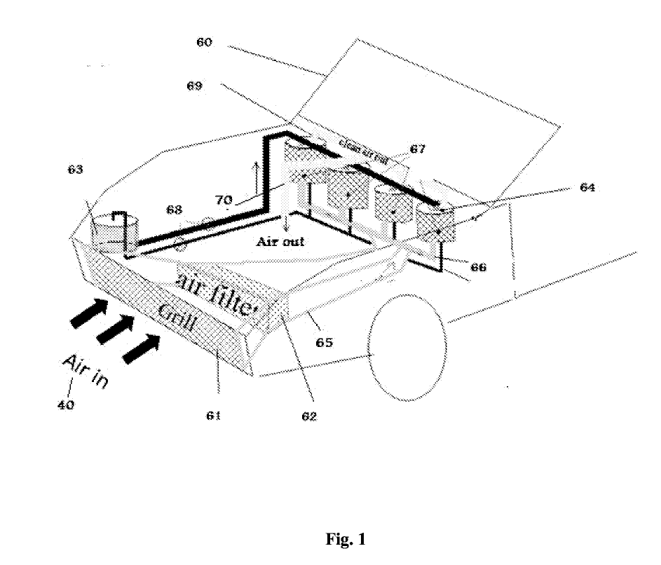

As mentioned above, various approaches exist for the capture of carbon dioxide. FIG. 1 represents an embodiment of the present invention with countercurrent flow of liquid and gas. The drawings are not necessarily to scale and should not be construed as limiting the scope, breath and applicability of the present invention. Referring to FIG. 1, ambient air 40 is introduced into vehicle encountering grill 61 and filtered via air filter 62. The introduction of air into vehicle may occur as a result of vehicle motion or due to the action of a fan powered by the vehicle. The conduit 65 serves to direct air via manifold 66 up to the reaction chambers 67, in which the carbon dioxide in the incoming air reacts with hydroxide-containing material in the reaction chambers. The reaction chamber may contain any high surface area material to maximize liquid-air contact, such as high surface area packed structures made of ceramic. The hydroxide-containing material may include solutions ranging from 0.1M to 15M in hydroxide. Air flow runs counter to the hydroxide solution which is shown to flow down to manifold 66. Hydroxide solution is dispensed via manifold 69 using diffuser 64.

After reaction, the formed carbonate ions are carried by the solution via pump assembly 68 to a hydroxide reservoir 63. Within or external of the hydroxide reservoir there may be a sensor, to determine the carbonate concentration within the solution. This sensor can depend on measuring spectroscopic signature of carbonyl stretches, for example. If the carbonate concentration is determined to be below a certain threshold, pump assembly 68 transports the hydroxide solution back to dispensing manifold 69 for more exposure to fresh air. After reaction, the air scrubbed of carbon dioxide can exit via manifold 70 to the motor engine, to a turbo or to the atmosphere.

In another countercurrent flow embodiment, NaOH is pumped through high surface area Raschig rings. Within these rings the NaOH encounters high speed air moving in the opposite direction. The carbonate-laden solution is pumped to a NaOH compartment that is separated from a NaOH reservoir by a siphon. The siphon serves to resist air going directly to the NaOH reservoir. It is expected that a plurality of air entry devices is put on the front of the vehicle. This arrangement is expected to cause increased overall automobile air resistance, but the higher engine efficiency should compensate for this decrease. It is expected that once a given level of carbonate is attained in the solution, as determined for example by conductivity readings, air passage through the CO₂ capture device would be bypassed.

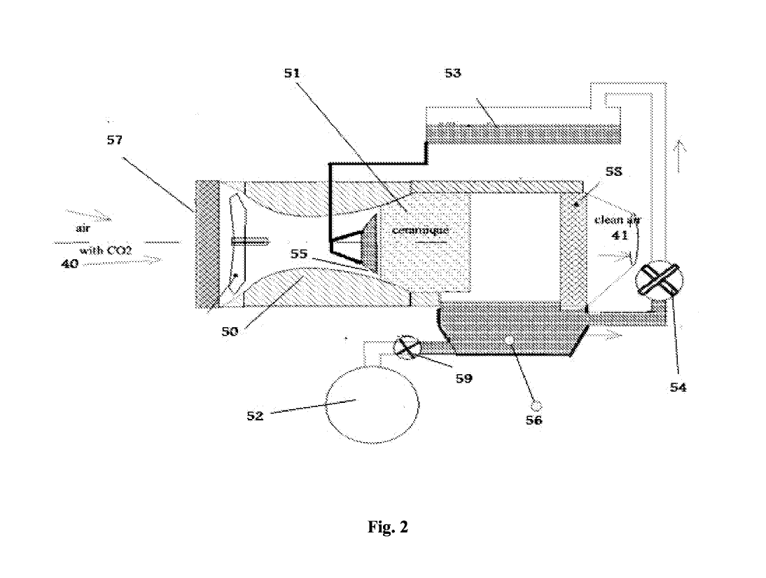

An embodiment incorporating concurrent flow of liquid and gas is illustrated in FIG. 2. Atmospheric air 40 is pulled in by fan 50 which is engine driven or driven by an electrical motor. A screen/air filter 57 is placed at the front of the vehicle to keep powder and debris out. A venturi system 55 is placed in-line to modify the air speed. Incoming air passed through Raschig rings 51 which receive hydroxide solution via sprayer 55. Carbonate-laden solution impacts a air/hydroxide separator 58 which allows passage of clean air 41 to the atmosphere or to the engine while retaining the hydroxide solution, which accumulates in container 56. The clean air will have a diminished concentration of carbon dioxide. In some embodiments, clean air will exit with carbon dioxide concentration of less than 380 ppm. In other embodiments, with a high molarity hydroxide and repeated cycling, the carbon dioxide concentration can be less than 300 ppm. Pump 54 carries the hydroxide solution to holding chamber 53. Hydroxide flow into the sprayer 55 is gravity driven. Electric pump 56 can transfer hydroxide solution to an exchangeable reservoir 52 once the hydroxide solution attains a desired carbonate concentration. Some embodiments stop the scrubbing at carbonate concentrations from 1% to 50% by weight of hydroxide.

Once the CO₂ is released from the carbonate off-site, the CO₂ can be sequestered. Carbon dioxide sequestration is a well known technique used presently by a variety of companies to bury the CO₂ and avoid paying CO₂ taxes. The sequestration involves injecting compressed CO₂ into an abandoned oil reservoir or aquifer in supercritical form. Retention times are said to be of order of hundreds to thousands of years with greater than 99% probability. The present invention is applicable to engines in boats, light airplanes, heavy trucks, and other mobile equipment.

1. A system for capturing carbon dioxide from the atmosphere comprising:
i) A means for introducing air into a vehicle during normal operation of vehicle
ii) A means for reacting said carbon dioxide in said air with hydroxide-containing material in a reaction vessel contained within vehicle
iii) A means for determining the concentration of carbonate in a hydroxide-containing solution that circulates within the vehicle
iv) A means for stopping or diverting the flow of air into reaction vessels once the carbonate concentration in the hydroxide-containing solution exceeds a threshold level.

2. A system according to claim 1 in which air is introduced at speeds ranging from 0 m/sec to 60 m/sec.

3. A system according to claim 1 in which air is introduced into a vehicle with an air-cooled engine

4. A system according to claim 1 in which air is introduced into a vehicle with a liquid-cooled engine

5. A system according to claim 1 in which carbon dioxide in said air is reacted with hydroxide-containing material by flowing countercurrently to the hydroxide-containing material

6. A system according to claim 1 in which carbon dioxide in said air is reacted with hydroxide-containing material by flowing concurrently to the hydroxide-containing material.

7. A system according to claim 1 in which the hydroxide-containing material ranges in molarity from 0.1M to 15M hydroxide ions.

8. A system according to claim 1 in which the threshold level ranges from 1% to 50% carbonate salt concentration by weight of hydroxide.

9. A system according to claim 1 in which the air exits to at least one of the following: the atmosphere, vehicle engine, vehicle turbo.

10. A system according to claim 1 in which air exits with carbon dioxide concentration less than 380 ppm.

11. A system for capturing carbon dioxide from the atmosphere comprising:
i) A means for introducing air into a vehicle possessing a 5 cylinder engine, wherein each cylinder has two compressible chambers, during normal operation of vehicle
ii) A means for reacting said carbon dioxide in said air with hydroxide-containing material in a reaction vessel contained within vehicle
iii) A means for determining the concentration of carbonate in a hydroxide-containing solution that circulates within the vehicle
iv) A means for stopping or diverting the flow of air into reaction vessels once the carbonate concentration in the hydroxide-containing solution exceeds a threshold level.

12. A system according to claim 11 in which air is introduced at speeds ranging from 0 m/sec to 60 m/sec.

13. A system according to claim 11 in which air is introduced into a vehicle with an air-cooled engine

14. A system according to claim 11 in which air is introduced into a vehicle with a liquid-cooled engine

15. A system according to claim 11 in which carbon dioxide in said air is reacted with hydroxide-containing material by flowing countercurrently to the hydroxide-containing material

16. A system according to claim 11 in which carbon dioxide in said air is reacted with hydroxide-containing material by flowing concurrently to the hydroxide-containing material.

17. A system according to claim 11 in which the hydroxide-containing material ranges in molarity from 0.1M to 15M hydroxide ions.

18. A system according to claim 11 in which the threshold level ranges from 1% to 50% carbonate salt concentration by weight of hydroxide.

19. A system according to claim 11 in which the air exits to at least one of the following: the atmosphere, vehicle engine, vehicle turbo.

20. A system according to claim 11 in which air exits with carbon dioxide concentration less than 380 ppm.
